(19) United States
(12) Patent Application Publication
(10) Pub. No.: US 2002/0051262 A1
(43) Pub. Date: May 2, 2002

(54) Image capture device with handwritten annotation

(76) Inventors: Gordon R. Nuttall, Fort Collins, CO (US); Robert E. Sobol, Ft. Collins, CO (US)

Correspondence Address: HEWLETT-PACKARD COMPANY, Intellectual Property Administraion, P.O. Box 272400, Fort Collins, CO, 80527-2400, US

(21) Appl. No.: 09/845,389

(22) Filed: Apr. 30, 2001

Related U.S. Application Data
(63) Continuation-in-part of application No. 09/525,094, filed on Mar. 14, 2000.

(51) Int. Cl. H04N 1/46

(52) U.S. Cl. 358/537

(57) ABSTRACT

The present invention is directed to an image data capture device for editing captured image data, the device generally including at least one image data capture element, an image data processor for generating image files from image data acquired by the capture element, and a user data entry device for enabling a user to modify image files. Preferably, one or more image data capture elements, the image data processor, and the user data entry device are disposed within a portable container.

### BACKGROUND

It is generally desirable when scanning images to convert raw image data into a usable image file format and ultimately to transmit such formatted images via various electronic communication means including e-mail and video transmission. Generally, prior art scanners were limited to operating under direct computer control, generating raw image data in response to scanning photographs or other images, and transmitting the raw image data to a personal computer or other intelligent device. Generally, the personal computer controlling the scanner would then convert the raw image data into a usable data format, perform any desired manipulation of the formatted image data, and where desired, transmit the formatted image data to a desired destination. Such prior art scanners generally lack portability since they may only be operated under control of an external device such as a personal computer. Moreover, the ability to control the manipulation of data to alter the appearance of images, the storage of image data files, and the communication of image data employing various mechanisms to other storage and/or display devices generally resides within a controlling device such as a personal computer rather than the scanner itself.

A commonly assigned U.S. patent application Ser. No. 09/525/094 describes an “e-scanner” which incorporates various features previously resident in personal computers into a substantially independent e-scanner able to perform its own conversions from raw image data to usable image data formats and to transmit files having converted image data to a personal computer.

Although the commonly assigned e-scanner is able to operate more independently of external devices than are prior art scanners, image files are generally transmitted to a separate device, such as a personal computer, in order to perform further operations on the image file. Such additional operations may include electronically mailing or transmitting the image file to a selected destination address, including the image in a web page, or including the image in a photo album under development.

Accordingly, it is a problem in the art that after an image is scanned, the identification of a subsequent step in the processing of such image must generally be performed employing a device external to the scanner.

It is a further problem in the art that in between the time at which an image is scanned and the time at which subsequent processing of the image occurs employing an external device, an original user intention regarding the handling of the image and/or the user's desired editing of the image may be forgotten.

### SUMMARY OF THE INVENTION

The present invention is directed to an image data capture device for editing captured image data, the device generally including at least one image data capture element, an image data processor for generating image files from image data acquired by the capture element, and a user data entry device for enabling a user to modify image files. Preferably, one or more image data capture elements, the image data processor, and the user data entry device are disposed within a portable container.

### BRIEF DESCRIPTION OF THE DRAWING

FIG. 1A depicts a perspective view of the bottom side of a scanner according to a preferred embodiment of the present invention;

FIG. 1B depicts a top view of a scanner according to a preferred embodiment of the present invention;

FIG. 2 depicts a functional block diagram of the operation of a scanner according to a preferred embodiment of the present invention;

FIG. 3 depicts a data entry screen for presentation to a user of a scanner according to a preferred embodiment of the present invention;

FIG. 4 depicts the data entry screen of FIG. 3 after data entry by a user according to a preferred embodiment of the present invention; and

FIG. 5 depicts data processing equipment adaptable for use with a preferred embodiment of the present invention.

### DETAILED DESCRIPTION

The present invention is directed to a system and method which enables a user to input data to a scanner or other data capture device to designate an intended treatment of data captured by the data capture device substantially immediately after the data is captured. Providing a data capture device user with the ability to designate the intended treatment of the captured data preferably provides for the preservation of user intention regarding the handling of the captured data at a point in time substantially contemporaneous with the acquisition of such data, thereby more accurately and more effectively directing the future treatment of such acquired data than was available in the prior art.

Where the data capture device is a scanner and the captured data is image data, the inventive device may receive input from a user allowing the user the modify the image, to direct the future treatment of the image, and/or to indicate a storage or transmission destination of the image. For example, where a photograph has been scanned, the user may enter text or graphic symbols to be entered into the image (in either handwritten form or via a keyboard) and designate a treatment of the image, such as incorporation of the image into a web page or email transmission to a designated set of recipients. The user could preferably also indicate a preferred method of cataloguing the stored image according to a readily remembered access word, index word, or code for subsequent retrieval.

In a preferred embodiment, a pressure sensitive tablet could be disposed on the scanner structure to enable user data entry for modification and identification of scanned images. For example, a tablet coupled with a handwriting recognition system could enable a user to scan a photograph and enter text by hand identifying the photograph (for example: “John's goal during soccer match against Uptown High school”) and instructions for the future handling of the data, such as, for instance, “email to Pete, Nancy, and Susan.”

While the above discussion concerns the case of annotating a scanned image and designating a subsequent treatment of a scanned and possibly annotated image, it will be appreciated that the present invention is applicable to stored data formats other than scanned images and to annotation data other than graphical data. For example, audio data samples could be annotated with voice or other types of data and coupled with instructions for storage or transmission to designated locations. The present invention is similarly adaptable to other data formats including video data. Moreover, scanned images could also be annotated with data other than graphical and text data, such as, for instance, audio data and/or video data.

In a preferred embodiment of the present invention, the scanner or other data capture device includes a communication port adaptable for transmission over a shared local area network and/or a wide area network such as the Internet to enable transmission of stored data directly from the image capture device to a remotely located node on the pertinent network, thereby preferably obviating a need for direct attachment of the scanner or other data capture device to a personal computer for such network communication purposes. Alternatively, the present invention could omit a direct network connection but still include the ability to prepare data for transmission over a network.

Accordingly, it is an advantage of a preferred embodiment of the present invention that an image file may be annotated employing a portable scanning device without requiring connection of this device to a personal computer.

It is a further advantage of a preferred embodiment of the present invention that acquired data may be entered by a user linking instructions for future handling of an acquired data file with such a file in a manner substantially contemporaneous with the acquisition of the data, thereby enabling the user to readily establish the desired treatment of the acquired data file.

It is a still further advantage of a preferred embodiment of the present invention that the above-mentioned annotation and data transmission capabilities are incorporated into a data capture device thereby enabling annotation and data transmission to be implemented by the data capture device at locations located remotely from a personal computer.

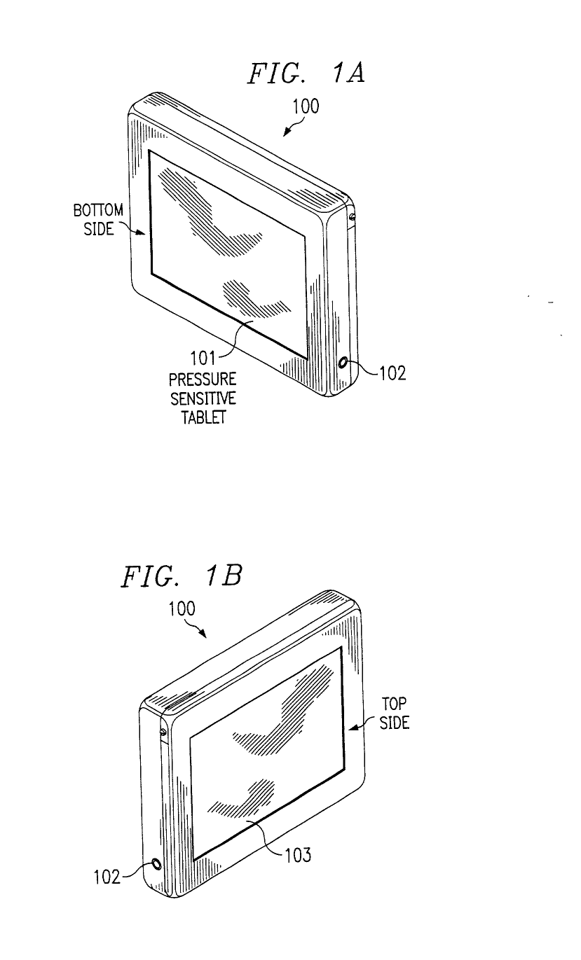

FIG. 1A depicts a perspective view of the lower side of scanner 100 according to a preferred embodiment of the present invention. Scanner 100 is preferably a modified version of the “e-scanner” described in commonly assigned U.S. patent application Ser. No. 09/525,094. Communication port 102 preferably enables scanner 100 to communicate over the local area networks as well as wide area networks including the Internet.

In a preferred embodiment, scanner 100 includes user data entry device 101, which may be a pressure sensitive tablet, for enabling users to enter data to scanner 100 to modify data captured by scanner 100 and to perform subsequent steps involving the data, such as, for instance, electronically mailing a data file to selected recipients and/or storing the data file under a selected file name. Generally, the upper side of the scanner, shown in FIG. 1B, includes a surface on which an image to be scanned may be placed in order to acquire image data therefrom. Scanner 100 preferably includes one or more data capture elements, such as data capture element 103, for receiving image data from any item being scanned. Data capture from objects being scanned is known in the art and will therefore not be discussed in detail herein.

In a preferred embodiment, pressure-sensitive tablet 101 enables a user to enter data both for inclusion within image files and/or for entering instructions to be performed on such image files. Preferably, a handwriting recognition mechanism, optionally including object character recognition, is employed in conjunction with pressure-sensitive tablet 101 to convert handwriting into recognizable text characters for the purpose of identifying specific instructions included within handwritten image data.

In a preferred embodiment, in addition to inputting instruction information, handwriting data input may be employed to insert text and/or image data into image data files initially generated from scanned data. Such inserted data may include text annotations describing the subject matter of a photograph, or other scanned image, and/or hand-drawn graphical images to be incorporated into a scanned image. For example, where an image contains a large number of like images, arrows, circles or other graphical images may be advantageously employed to identify a point of particular interest within a photograph, drawing, or other image, which graphical image may be accompanied by text relating to the graphically identified point of interest. For example, where the scanned image is a photograph of a sports action shot, an arrow may be introduced to identify an object in the photograph, which may have diminished visibility, such as a fast-moving hockey puck or soccer ball. Where the initial positioning of such a graphical image, such as a line, circle, or arrow, is not well suited to the item of interest in the photograph, the position of the item could later be adjusted employing a graphics program within a personal computer or possibly within the scanner 100 itself.

In a preferred embodiment, a display of the scanned image could be presented to the user in such a way as to enable user inputted text and graphical symbols to be superimposed on a display of the scanned image. In this manner, the user could accurately locate such text and graphical images in desired locations with respect to objects of interest originally present in the scanned image. Moreover, the ability to superimpose such entries over the scanned image employing a portable device advantageously enables a user to enter such text and graphical data substantially contemporaneously with the scanning of the image, thereby enabling a user's ideas regarding the annotation of a photograph or other scanned image to be entered while still fresh in the mind of the user.

While the above discussion refers to the use of a pressure-sensitive tablet as a user data entry device, it will be appreciated that other user data entry devices could be employed to provide both annotation data as well as instructions for processing of an image data file. Alternative user data entry devices preferably include but are not limited to a keyboard, microphone for voice input, computer mouse, and a computer data communication port for receiving text data, graphical data, voice data or other data format.

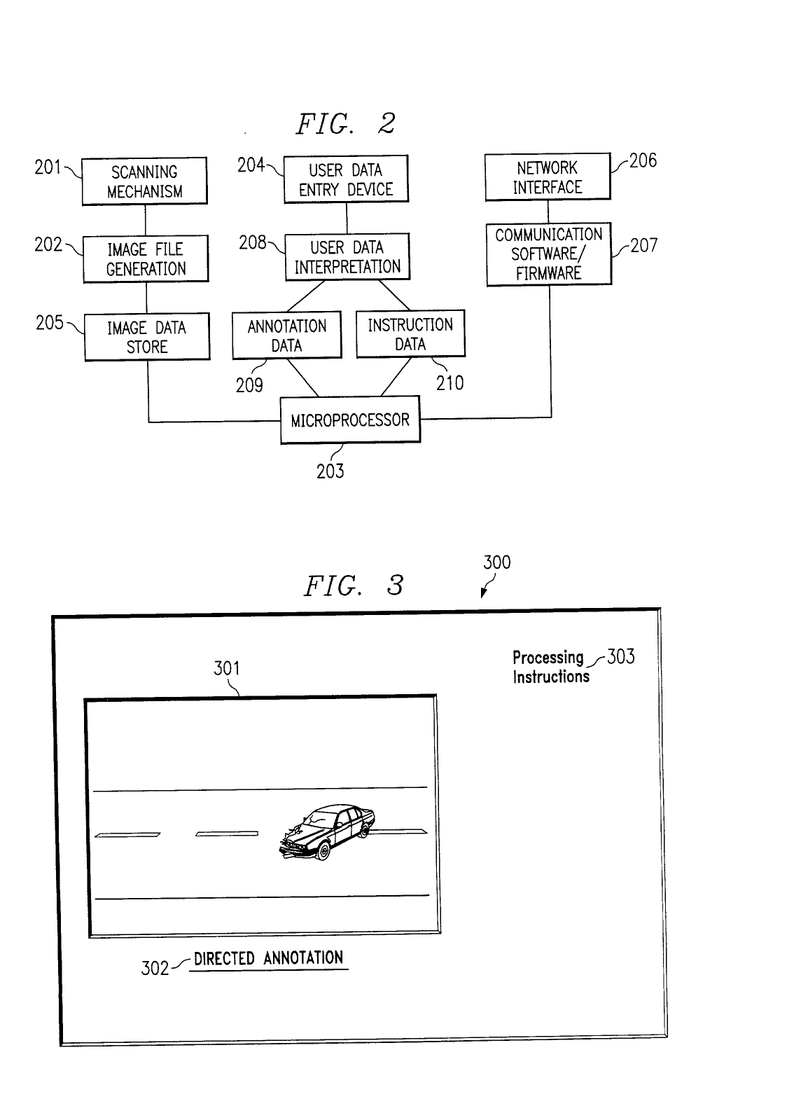

FIG. 2 depicts a functional block diagram of the operation of scanner 100 according to a preferred embodiment of the present invention. In a preferred embodiment, scanning mechanism 201 employs an optical sensor (not shown) such as, for instance, a CCD (charge coupled device) or CIS (contact image sensor). Scanning mechanism 201 preferably further includes means for moving an image to be scanned with respect to the optical sensor being employed. Such relative motion may include moving an image to be scanned with respect to a substantially stationary optical sensor, moving an optical sensor with respect to a substantially stationary image to be scanned, or a combination of the two types of aforementioned motion. The optical scanning equipment is preferably arranged so that optical sensor's width fully spans the width of the object to be scanned, or otherwise stated, the dimension of the object or image to be scanned which is perpendicular to the direction of relative motion between the image to be scanned and the optical sensor.

In a preferred embodiment, image file generation 202 is accomplished employing firmware and hardware to convert raw image data acquired by scanning mechanism 201 into an image file usable by microprocessor 203. After an image file is generated by image file generation 202 the image data is preferably stored, as indicated by the image data store block 205, for future access by microprocessor 203. Microprocessor 203 preferably includes its own memory and embedded operating system for controlling scanning mechanism 201, interacting with image file generation mechanism 202, and coordinating the operation of various components of scanner 100. Preferably, microprocessor 203 and image file generation mechanism 202 cooperate to enable the conversion of analog sensor data into digital data and to enable a DMA (direct memory access) controller to move linear data from an image sensor into a data buffer in communication with microprocessor 203. Microprocessor 203 may also be employed to perform scaling of the image data such as scaling, sizing, auto-cropping, compression, exposure adjustment, sharpening, and red-eye removal.

In a preferred embodiment, user data entry device 204 is preferably employed to receive data from a user to annotate an image file and/or to provide instructions for the subsequent handling of the image file. User data entry device 204 may be a pressure-sensitive tablet to enable a user to “write” on the tablet employing an appropriate instrument for imparting pressure to such a tablet. In this manner, user data entry device 204, in combination with appropriate user data interpretation mechanism 208 which may include handwriting recognition functionality, may be employed to convert handwritten information submitted by a user employing a pressure sensitive tablet into either annotation data 209 or instruction data 210. Generally, annotation data 209 is processed so as to be included within the image file itself while instruction data 210 is generally converted into discrete instructions describing subsequent processing of the image file. Technologies other than pressure sensitive pads may be employed for receiving handwritten user input, such as, for instance, a pen and pad surface which are electromagnetically coupled.

In a preferred embodiment, annotation data 209 may include user entered text for modification of an image file. For example, user-entered handwritten text may be interpreted 208 as written characters, converted into printed text characters, and the printed text characters then inserted into an existing image file. User-entered annotation data may also include data of other types, including but not limited to graphical data, video data, and audio data. User-entered data may also be converted to text and inserted as the body text of the email message.

In a preferred embodiment, image data may include various hand drawn images intended to enhance or modify the scanned image such as, for instance, arrows pointing to points of interest within a scanned image and/or circles or other graphic shapes encircling or placed adjacent to points of interest. User-entered text and/or graphic data may be entered independently of any display of the scanned image and then re-located on the scanned image by direction or by subsequent image manipulation. Alternatively, user-entered text and/or images may be entered on a screen which superimposes user-entered data on top of a display of the image file concerned so that the user can manually place annotations exactly where desired within the image. Where the user enters information either in the form of handwritten text characters or graphical symbols, the user is preferably able to instruct the inventive mechanism to either exactly reproduce the style and shape of the entered characters or alternatively, to have a symbol recognition program operate on the symbols to convert them into standardized computer-generated symbols. Thus, a handwritten “E” text character could either be left in handwritten form for stylistic purposes, or alternatively, be converted into a computer-generated “E” character in order to present the character employing a generally recognized printed text font.

In addition to including image data for annotation within an image file, data in other formats such as, for instance, audio and video data could be included in and/or linked to an image file. For example, where a photograph displays a dramatic sports event, the user could enter voice data pertaining to the event, or associate music or other audio data suitably connected to the event to the image file so as to enable this audio data either be played automatically upon subsequent viewing of the image file by a recipient or to at least be readily accessible to such a recipient of the image file, such as, for instance, by pressing a mechanical button or clicking on a computer icon.

In a preferred embodiment, user data interpretation mechanism 208 may recognize instruction data 210 within information provided by user data entry device 204. Preferably, microprocessor 203 converts instruction data 210 into specific instructions for handling an image file which may or may not contain annotation data 209. Subsequent processing of an image file preferably proceeds according to instructions derived from user entered instruction data 210, which processing may include, for instance, e-mailing the image file to a designated group of recipients, storing the image file in a designated location, and/or modifying the image file according to a set of user preferences.

In a preferred embodiment, network interface 206 provides the inventive scanner with connectivity to various types of external networks including but not limited to LANs (Local Area Networks), WANs (Wide Area Networks) including the Internet, and wireless networks. Moreover, network interface 206, in addition to being compatible with various physical network formats is preferably able to support a range of possible communication protocols associated with various network configurations, such as, for instance, Ethernet, BLUETOOTH, and wired or wireless interfaces such as, for instance, Infrared, IEEE 802.3, POTS (Plain Old Telephone Service), ISDN (Integrated Services Digital Network), cable, and/or DSL (Digital Subscriber Line). Available protocols include TCP/IP (Transmission Control Protocol/Internet Protocol), FTP (File Transfer Protocol), and XML (extensible Markup Language). The provision of network interface 206, in combination with communication software and firmware 207 advantageously enables scanner 100 to transmit/receive information to/from the Internet and/or other networks, thereby enabling the inventive scanner 100 to communicate over the various network types without the need for attachment of scanner 100 to a personal computer or other external device.

In a preferred embodiment, communication software and firmware 207 is implemented within scanner 100 in order to provide the inventive scanner with communication functionality which in the prior art, was found primarily in personal computers. Communication software 207 preferably includes email transmission and reception functionality in addition to the ability to connect to Internet service providers. Moreover, communication software 207 preferably further includes the ability, upon being coupled to an appropriate network connection, to store an image file in a designated location either in a photo album or on a hard drive or other non-volatile storage device. Software 207 preferably further includes the ability to generate Internet web pages from such images files. Preferably, the implementation of the above-described communication abilities within the inventive scanner enhance the ability of the scanner to provide a full service solution to a portable scanner without the need to rely upon connection to a separate and less mobile processing device such as a personal computer. Memory for use in image data store operation 205 could be non-volatile removable storage such as, for instance, COMPACT FLASH, Smartmedia, and/or rotating magnetic or optical media.

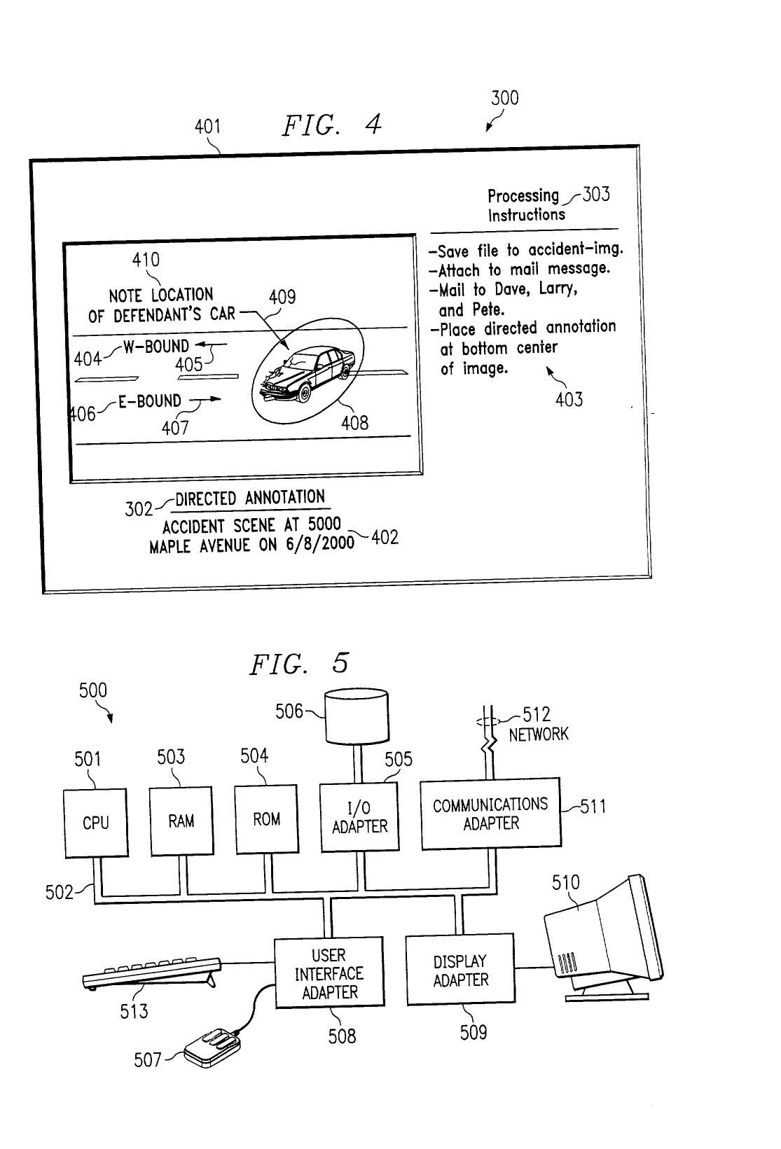

FIG. 3 depicts a data entry screen or display 300 for presentation to a user of a scanner according to a preferred embodiment of the present invention. Preferably, display 300 operates so as to enable handwriting motions on the part of a user to be digitally recorded and graphically reproduced onto the same display 300 on which image 301 is displayed, thereby enabling superimposition of user-entered markings over image 301. FIG. 3 displays the condition of display 300 prior to user entry while FIG. 4 displays the condition of the display after user data entry. Technology for implementing such recording of user markings (graphical data entry mechanism) may include but is not limited to pressure-sensitive tablets and an electromagnetically coupled pen and surface able to discern and record the relative location of the pen with respect to the surface to which it is coupled, and/or an electronic keyboard with or without a computer mouse, short distance radio communication, and capacitively coupled surfaces.

In a preferred embodiment, a user will be able to add graphical information to an image, such as image 301 employing a selected graphical data entry mechanism. Preferably, the present invention enables users to enter both graphical information for addition to an image as well as instructions for handling the image. FIG. 3 depicts display 300 prior to entry of annotations or instructions by a user. Display 300 preferably includes original image 301, a designated location for entering directed annotations 302, and a designated location for entering processing instructions 303.

FIG. 4 depicts display 300 after having been modified 400 by user entry of an exemplary set of annotations and instructions. FIG. 4 includes both directed annotations 402 and exemplary superimposed annotations 404-410. FIG. 4 also depicts user-entered processing instructions 403 entered in the designated location for entering processing instructions 303.

Continuing with the example, modified image 401 includes the contents of original image 301 (FIG. 3) as well as superimposed annotations 404-410. In this example, the image being annotated is that of a car accident photograph. Accordingly, a selection of graphical symbols and text strings pertaining to elements of the accident are provided as exemplary annotations.

Continuing with the example, text string “E-bound” 407 and accompanying arrow 407 have been added to the image as superimposed annotations to indicate the direction of a first side of the street on which the accident occurred. In similar manner, text string “W-bound” 404 and accompanying arrow 405 are annotations superimposed on original image 301 to show a second side of the street. Loop or circle 408 shown fully encircling a vehicle has been added as a graphical superimposed illustration to highlight the vehicle and its location on the street. Such a loop may be advantageously employed to draw attention to a point of particular interest within an image as has been done in this case with respect to the circled automobile. In addition, the addition of loop 408, text string 410, and accompanying arrow 409 have been added to original image 301 to further identify and highlight the automobile involved in the accident. Generally, where text is added by superimposed annotation, the actual hand-drawn text images entered by the user will be included in the image being modified 401. Alternatively however, handwriting interpretation may be employed to process the user's handwriting and produce computer generated text corresponding the handwritten text strings entered by the user.

Having discussed the annotations added by superimposition, it remains to discuss annotations which may be added by direction. In the case of annotation by direction, text strings such as text string 402, may be entered in a location which is not actively displaying the image to be modified, such as, for instance, directed annotation entry location 302.

Annotation by direction preferably includes entering a text string to be included in the image to be modified and then indicating a preferred location in the image where the annotation text may be added. Alternatively, the inventive mechanism could select a blank portion of the image as a default location for annotation text entry, if no preferred location is identified.

In a preferred embodiment, the inventive mechanism provides a user with the ability to enter instructions for execution by the inventive scanner or other computing entity in communication with the scanner in addition to data entered in order to modify an original image. Preferably, a mechanism is provided in order to decipher user text input intended to be acted upon as an instruction or, alternatively, user text input which is intended to be included in the image as a literal string. In the embodiment of FIG. 4, the inventive mechanism prompts the user to enter text intended to represent instructions in a different location of display 300 than text intended to be included in image 401. Alternatively to the text-entry location dependent approach, the inventive mechanism could prompt the user to select from a plurality of options regarding the intended purpose of text entry prior to, during, or after entry of the text concerned. Where the user indicates the intended purpose of the text (for annotation, instruction, or other purpose) before or after the actual entry of the text, the same display area could be used successively for entry of literal strings and for information indicating an intended treatment of such literal strings.

Continuing with the example, the user is preferably prompted to enter instructions in location 303 set aside for such entries. Four instructions 403 are shown having been entered by the user, which are, from top to bottom, “save file to accident-img,” “Attach to mail message,” “mail to Dave, Larry, and Pete,” and “place directed annotation at bottom center of image.” Upon reviewing the user-entered instruction information the inventive scanner preferably performs handwriting analysis on the handwritten entries to convert the individual characters into to machine-generated characters. Thereafter, the inventive scanner preferably interprets the sequences of characters to correlate the user-entered sequence of characters with distinct commands recognizable to the scanner. The scanner then preferably executes the instructions in the order entered, unless an alternate order is indicated by the user.

The above discussion concentrates on user data entry which is accomplished via handwritten entries input by the user employing a pressure-sensitive tablet, electromagnetically coupled pen and writing surface or other graphical data entry mechanism. Alternatively, however, other mechanisms could be employed for entry of various types of data. Specifically, a small keyboard (used either with or without a computer mouse) could be deployed in communication with the inventive scanner to transmit alpha-numeric characters to the scanner or a voice recognition system could be used. Moreover, a template containing including keys associated with a selection of standard graphical symbols such as, for instance, arrows, circles, and arcs, could be included in such a keyboard. Such graphical symbol keys could enable a user to enter a selection of standard graphical symbols in order to generate computer generated graphical output corresponding to the selected graphical symbol keys.

While the disclosed annotation scheme has been discussed primarily in the context of modifying images obtained by a scanner, it will be appreciated that the invention is applicable to other data capture devices including but not limited to digital cameras (both still and video) and analog cameras (both still and video). Where used with a digital camera, a display could be provided which enables a user to superimpose handwritten text annotations, graphical annotations, and instructions for future handling of a captured image (such as a digital photograph) at any time after a photo is taken. The process of receiving user data and acting upon user instructions would preferably occur in much the same manner for digital still cameras and/or digital video cameras as has been described above in connection with a scanning apparatus.

FIG. 5 illustrates computer system 500 adaptable for use with a preferred embodiment of the present invention. Central processing unit (CPU) 501 is coupled to system bus 502. The CPU 501 may be any general purpose CPU, such as an Hewlett Packard PA-8200. However, the present invention is not restricted by the architecture of CPU 501 as long as CPU 501 supports the inventive operations as described herein. Bus 502 is coupled to random access memory (RAM) 503, which may be SRAM, DRAM, or SDRAM. ROM 504 is also coupled to bus 502, which may be PROM, EPROM, or EEPROM. RAM 503 and ROM 504 hold user and system data and programs as is well known in the art.

Bus 502 is also coupled to input/output (1/0) adapter 505, communications adapter card 511, user interface adapter 508, and display adapter 509. I/O adapter 505 connects to storage devices 506, such as one or more of hard drive, CD drive, floppy disk drive, tape drive, to the computer system. Communications adapter 511 is adapted to couple the computer system 500 to a network 512, which may be one or more of local (LAN), wide-area (WAN), Ethernet or Internet network. User interface adapter 508 couples user input devices, such as keyboard 513 and pointing device 507, to computer system 500. Display adapter 509 is driven by CPU 501 to control the display on display device 510.

What is claimed is:

1. An image data capture device for editing captured image data, the device comprising:
at least one image data capture element;
an image data processor for generating image files from image data acquired by said capture element; and
a user data entry device for enabling a user to modify said generated image files, wherein said at least said one image data capture element, said image data processor, and said user data entry device are disposed within a portable container.

2. The device of claim 1 wherein said image data capture element is included in a digital camera.

3. The device of claim 1 wherein said image data capture element is included in a scanner.

4. The device of claim 1 wherein said user data entry device comprises:
a pressure-sensitive tablet.

5. The device of claim 1 wherein said user data entry device comprises:
an electromagnetically coupled pen and writing surface.

6. The device of claim 1 wherein said user data entry device comprises:
means for entering text annotation data into said generated image files.

7. The device of claim 1 wherein said user data entry device comprises:
means for entering graphical annotation data into said generated image files.

8. The device of claim 1 further comprising:
means for entering image file processing instructions to said device.

9. The device of claim 1 further comprising:
means for converting handwritten user entries employing said user data entry device into machine recognizable data.

10. The device of claim 1 wherein said user data entry device enables superimposition of user data entry on a display of an image file of said generated image files.

11. The device of claim 1 wherein said user data entry device enables annotation of said generated image files by direction.

12. The device of claim 1 further comprising:
a communication interface for coupling said device to a network.

13. A method for annotating information in an image capture device, the method comprising the steps of:
capturing image data within said image capture device;
receiving user-entered data in connection with selected captured ones of said image data;
annotating said selected ones of said captured image data with said received user-entered data; and
performing said steps of capturing, receiving, and annotating within a portable assembly.

14. The method of claim 13 comprising the further step of:
providing a network interface within said portable assembly.

15. The method of claim 13 wherein said annotating step comprises the steps of:
displaying a first image file of selected captured image data;
superimposing said user-entered data on said displayed first image file; and
providing a continuously updated display of said first image file as modified by said user-entered data.

16. The method of claim 13 further comprising the step of:
electronically mailing said annotated selected ones of said at least one image files to at least one recipient, said recipient specified in said annotating step.

17. The method of claim 13 further comprising the step of:
saving said annotated selected ones of said image data.

18. The method of claim 17 wherein said step of saving comprises the step of:
transmitting said annotated selected ones of said image data over a public network to a node on said public network.

19. An optical scanner comprising:
means for capturing image data;
means for displaying selected image data;
means for receiving user-entered data in connection with said selected image data;
means for superimposing said received user-entered data on said displayed selected image data; and
means for annotating said displayed selected image data with said superimposed received user-entered data.

20. The optical scanner of claim 19 further comprising:
a communication interface for enabling said optical scanner to communicate over a data communication network, under at least partial control of said means for annotating.

21. The optical scanner of claim 19 wherein the means for receiving comprises:
means for receiving handwritten graphical data.
